(19) United States
(12) Patent Application Publication
(10) Pub. No.: US 2010/0294618 A1
(43) Pub. Date: Nov. 25, 2010

(54) Ice Agitation and Dispensing Device and Method

(75) Inventor: Michael T. Jennison, Cranberry Township, PA (US)

Correspondence Address: THE WEBB LAW FIRM, P.C., 700 KOPPERS BUILDING, 436 SEVENTH AVENUE, PITTSBURGH, PA, 15219, US

(73) Assignee: AKOONA, LLC, Charlestown, WI (US)

(21) Appl. No.: 12/789,748

(22) Filed: May 28, 2010

Related U.S. Application Data
(63) Continuation-in-part of application No. 12/670,536, filed on Apr. 7, 2010.
(60) Provisional application No. 60/962,500, filed on Jul. 30, 2007.

(51) Int. Cl. G07F 9/10; B67D 7/84; B67D 7/80; G08B 5/00

(52) U.S. Cl. 194/350; 222/167; 222/146.6; 340/815.4

(57) ABSTRACT

An ice dispensing system includes a housing having a first section coupled to a second section to form a substantially cylindrical opening therebetween. At least one of the first section and the second section has a first opening in fluid communication with an ice making machine and a second opening in fluid communication with an output chute. A rotating sleeve is positioned within the substantially cylindrical opening of the housing. The rotating sleeve has an inner surface, an outer surface, and an opening extending therebetween. The sleeve is configured to rotate from a first position to a second position. The opening has a geometry and size that directs ice within the sleeve and captures a regulated amount of the ice during rotation between the first position and the second position and dispenses the regulated amount of ice into the output chute when the sleeve reaches the second position.

### CROSS REFERENCE TO RELATED APPLICATIONS

This application is a continuation-in-part application of, and claims priority to, U.S. application Ser. No. 12/670,536, filed Jan. 25, 2010 entitled “Ice Agitation and Dispensing Device and Method”, which is a National Stage Application Under 35 U.S.C. §371 of International Application No. PCT/US2008/071416, filed Jul. 29, 2008, which claims priority to U.S. Provisional Application No. 60/962,500, filed Jul. 30, 2007, the entire disclosure of each application is herein incorporated by reference.

### BACKGROUND OF THE INVENTION

1. Field of the Invention

The present invention relates, in general, to a device and method for agitating and dispensing ice (cubes, crushed, cracked, flaked) from a common mass of stored ice.

2. Description of Related Art

Ice typically cannot be made at the time it is required so it is stored in a common mass and then dispensed accordingly. Ice storage bins are sometimes refrigerated but more typically are only insulated such that the mass of ice slowly melts after entering the bin. Generally, the problems to be overcome by an ice dispensing device and method are to operate consistently without jamming and to dispense a regulated and predictable amount of ice during each activation. Additionally, it is generally desirable for the dispensing method to have the ability to dispense ice consistently whether the storage bin is full or nearly empty, have the ability to dispense ice of various temperatures and consistencies (crunchy frozen ice to slushy melting ice and anything in between), have the ability to dispense ice of different types (various sizes and shapes of cubes, crushed, cracked, flaked), to dispense ice in a form consistent with its original form (crescent cubes, half cubes, crushed, cracked, flaked) and not in big chunks or clumps (agitating method), not dispense “bottom of the bin” ice that is usually the most watery, least desirable ice in the bin, and minimize airflow though the input/output opening(s) of the bin during dispensing to maintain lower temperatures inside the bin.

Methods for dispensing ice from a common mass of stored ice are known in the art. However, each of these methods suffers from various deficiencies that prevent them from achieving the above-described objectives. For instance, U.S. Pat. No. 6,607,096 to Glass et al. is directed to an apparatus and method for a volumetric ice dispensing and measuring device. However, this device is primarily a measuring device. The device dispenses ice using parts which move against ice and therefore can easily jam. Additionally, the device relies on an unreliable measuring of the flow of a solid to regulate the amount of ice dispensed and the device delivers ice from the “bottom of the bin”.

A second device for and method of dispensing ice is disclosed in U.S. Pat. No. 5,299,716 to Hawkins et al. This device follows a more common theme of “paddle wheel”, “auger”, or “conveyor” ice movers. A main feature of this type of ice dispensing device is “staging” ice before dispensing. Ice dispensing devices such as the one described in this reference will not reliably dispense regulated amounts of ice as the “staged” ice is always slowly melting and the time between dispensing activations is variable. Furthermore, this device relies on shaft driven agitators, wheels, conveyors, augers, and several other parts that move against ice during operation making it inherently unreliable, prone to jamming, and unpredictable.

An additional device for and method of dispensing ice is disclosed in U.S. Pat. No. 3,272,300 to Hoenisch. The device achieves several of the ice dispensing objectives discussed hereinabove; however, it also has moving parts which move against ice and relies on the unreliable physical responses of flowing ice in its loading and conveying mechanism.

A final ice dispensing device is disclosed in U.S. Pat. No. 4,062,476 to Brand et al. This device uses a rotatable supply container thereby eliminating the problem of moving parts against ice. However, it relies on internal fins to “convey” ice towards the discharge opening. Additionally, this device is portable, does not work with ice supply sources, and has no method for ice to enter the container.

Accordingly, a need exists for a simple, novel, inexpensive, ice dispensing method that is scalable, reliable, and can be used with existing commercial ice making machines. A further need exists for an ice dispensing device that dispenses a consistently regulated amount of ice after each activation without any need to measure and that does not include parts that move against ice thereby eliminating any chance of jamming.

### SUMMARY OF THE INVENTION

The present invention is directed to an ice dispensing system and method. The system and method of the present invention dispense a consistently regulated amount of ice during each activation without any need to measure and without any chance of jamming since there are no parts moving against ice. Additionally, the ice dispensing system and method of the present invention have the ability to dispense ice consistently whether the storage bin is full or nearly empty, have the ability to dispense ice of various temperatures and consistencies (crunchy frozen ice to slushy melting ice and anything in between), dispense ice of different types (various sizes and shapes of cubes, crushed, cracked, flaked), dispense ice in a form consistent with its original form (crescent cubes, half cubes, crushed, cracked, flaked) and not in big chunks or clumps (agitating method), not dispense “bottom of the bin” ice that is usually the most watery, least desirable ice in the bin, and minimize airflow though the input/output opening(s) of the bin during dispensing to maintain lower temperatures inside the bin.

The present invention is directed to an ice dispensing system that includes a housing having a first section coupled to a second section to form a substantially cylindrical opening therebetween. At least one of the first section and the second section has a first opening in fluid communication with an ice making machine and a second opening in fluid communication with an output chute. The ice dispensing system also includes a rotating sleeve positioned within the substantially cylindrical opening of the housing. The rotating sleeve has an inner surface, an outer surface, and an opening extending between the inner surface and the outer surface. The sleeve is configured to rotate from a first position in which the opening aligns with the first opening of the housing to a second position in which the opening aligns with the second opening of the housing. The opening has a geometry and size that directs ice within the sleeve and captures a regulated amount of the ice during rotation between the first position and the second position and dispenses the regulated amount of ice into the output chute when the sleeve reaches the second position.

The ice dispensing system may further comprise a drive system coupled to the sleeve for rotating the sleeve between the first position and the second position. The drive system may include a rotating gear configured to interact with teeth provided on the outer surface of the sleeve to cause rotation of the sleeve. The drive system may include a braking system for stopping rotation of the sleeve once it returns to the first position.

At least one projection may be provided that extends from the inner surface of the sleeve for directing ice within the sleeve. The rotation of the sleeve and the at least one projection may agitate the ice within the sleeve. The first section and the second section of the housing may be injection molded from a polymeric material.

The ice dispensing system may be positioned within a vending machine housing. The vending machine housing may include at least one of a dispensing actuation interface, a payment interface, and a bag dispensing interface. The vending machine housing may also include a visual display for providing an indication to the user of the stage of dispensing.

The present invention is also an ice dispensing system that includes: a rotating housing having a substantially cylindrical body portion with an inner surface, an outer surface, an opening extending between the inner surface and the outer surface and provided in fluid communication with an ice making machine when the housing is in a first position, and an ice receiving notch formed in the inner surface; and a sleeve positioned within the cylindrical body portion of the housing. The sleeve includes an inner surface, an outer surface, a first opening extending between the inner surface and the outer surface and in fluid communication with the opening in the housing when the housing is in the first position, and a second opening extending between the inner surface and the outer surface and in fluid communication with the ice receiving notch in the housing when the housing is in a second position. The ice dispensing system also includes an output chute in fluid communication with the ice receiving notch of the housing when the housing is in a third position. The housing is configured to rotate from a first position to a third position, and the ice receiving notch has a geometry and size that receives ice from within the sleeve and captures a regulated amount of the ice during rotation of the housing between the first position and the second position and dispenses the regulated amount of ice into the output chute when the housing reaches the third position.

The ice dispensing system may further include a drive system coupled to the housing for rotating the housing between the first position and the third position. The drive system may include a rotating gear configured to interact with teeth provided on the outer surface of the housing to cause rotation of the housing. The drive system may also include a braking system for stopping rotation of the housing once it returns to the first position.

The sleeve may further include at least one projection extending from the inner surface of the sleeve for directing ice within the sleeve. The sleeve may be configured to remain stationary as the housing rotates. The housing and the sleeve may be injection molded from a polymeric material. The ice dispensing system may be positioned within a vending machine housing. The vending machine housing may include at least one of a dispensing actuation interface, a payment interface, and a bag dispensing interface. The vending machine housing may include a visual display for providing an indication to the user of the stage of dispensing.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an”, and “the” include plural referents unless the context clearly dictates otherwise.

### BRIEF DESCRIPTION OF THE DRAWINGS

FIG. 1 is a perspective view of an ice dispensing system in accordance with the present invention;

FIG. 2 is a detailed cross-sectional view of the ice dispensing system of FIG. 1 with a barrel of the ice dispensing system in a first position;

FIG. 3 is a detailed cross-sectional view of the ice dispensing system of FIG. 1 with the barrel in a second position;

FIG. 4 is a perspective view of an alternative embodiment of an ice dispensing system in accordance with the present invention;

FIG. 5 is a cross-sectional view of the ice dispensing system taken along line 5-5 in FIG. 4;

FIG. 6 is a perspective view of an alternative embodiment of an ice dispensing system in accordance with the present invention;

FIGS. 7(a) through 7(c) are cross-sectional views of the ice dispensing system of FIG. 6 with the housing in first, second, and third positions, respectively; and

FIG. 8 is a perspective view of a housing assembly for the ice dispensing system in accordance with the present invention.

### DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

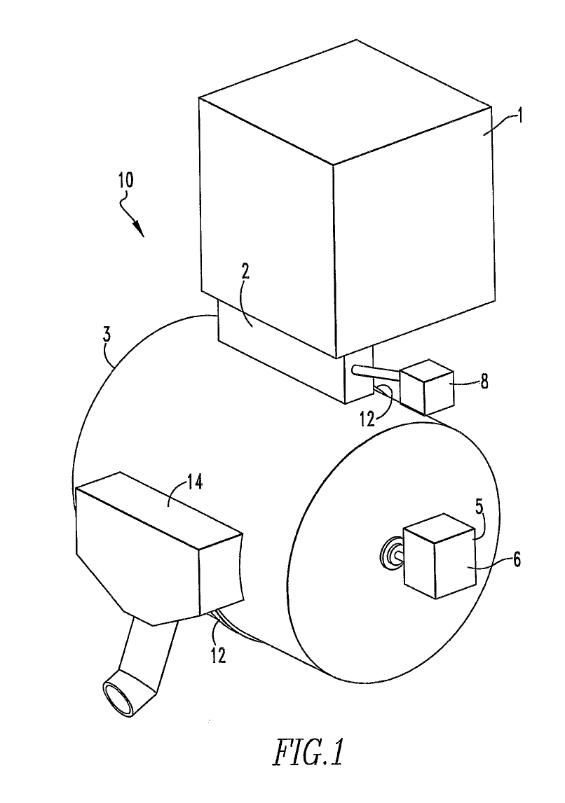

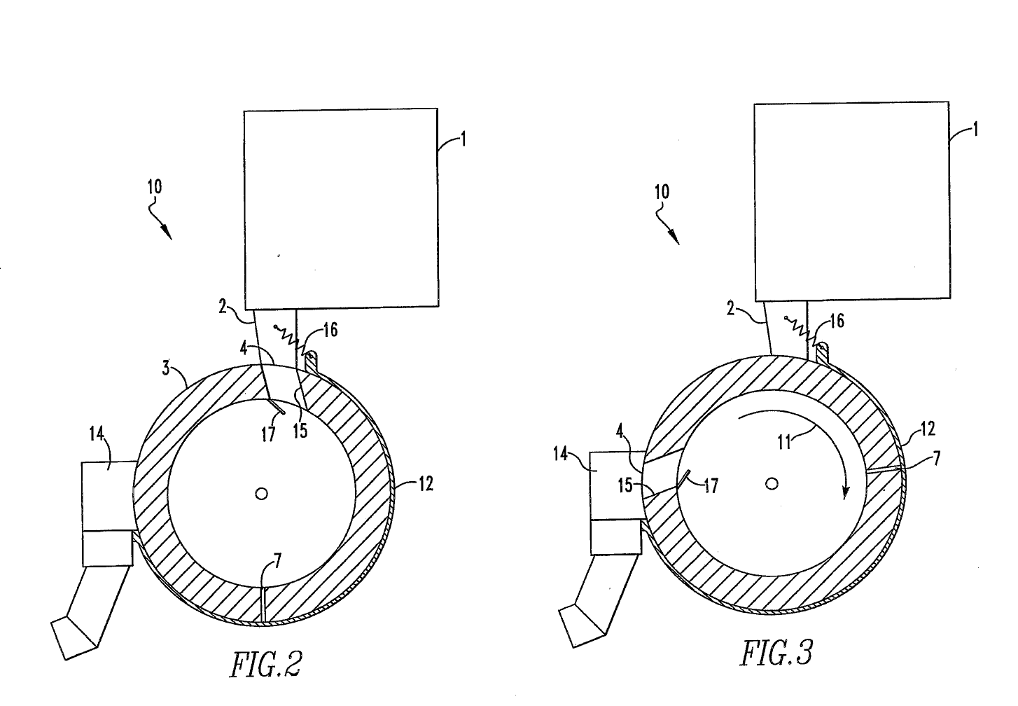

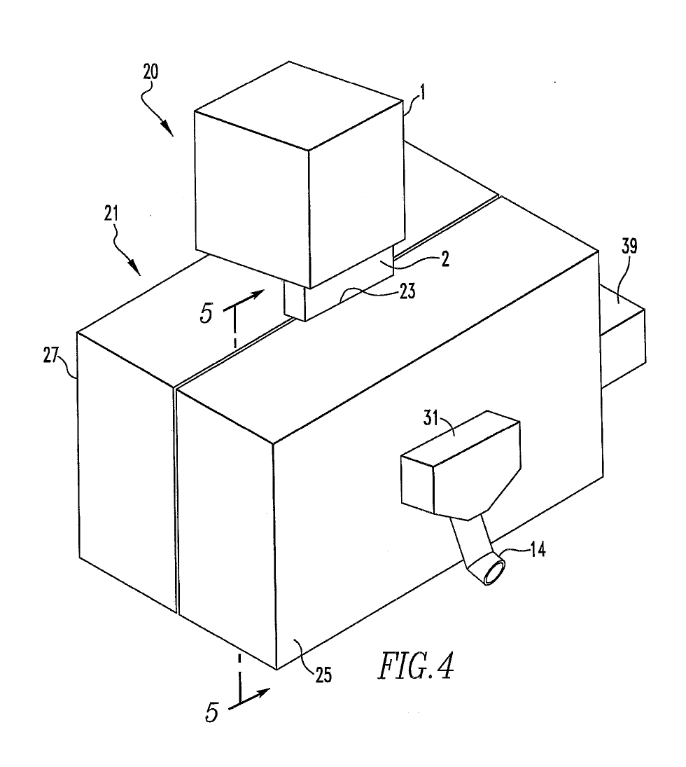

With reference to FIG. 1, an ice dispensing system 10 includes an input chute 2, communicating and directing ice into a main ice barrel 3 though a barrel opening 4 (see FIGS. 2 and 3). Input chute 2 is positioned under any conventional ice machine 1 of various types, makes, and manufacturers in place of where an ice holding bin would typically be placed. Conventional ice making machine 1 supplies various forms of ice (cubes, crushed, cracked, flaked) to the ice dispensing system of the present invention. The ice produced by ice making machine 1 falls into the dispensing system's input chute 2 and then directly into main ice barrel 3 through opening 4.

With reference to FIG. 2 and with continuing reference to FIG. 1, ice barrel 3 has an insulated cylindrical body with one large barrel opening 4 where ice enters/exits and at least one small drain hole 7. Barrel 3 may include a mounting flange extending from a first end and a mounting flange extending from a second end. The mounting flanges are used to mount barrel 3 to an appropriate drive mechanism. Alternatively, barrel 3 may be mounted on a horizontal shaft. Using either mounting configuration, barrel 3 is mounted such that it rotates during operation using a drive system 5 comprising either a human powered lever for small scale units or a powered drive (such as an AC motor) for larger units as will be discussed in greater detail hereinafter. Barrel 3 includes a body that has a cylindrical shape on the outside and a basically cylindrical shape on the inside except for the geometry and size 15 of opening 4 which is contoured so that when opening 4 is rotated, a regulated amount of ice is directed, flows, and is captured for dispensing. In addition, a blade or scoop 17 may be added near opening 4 to aid opening 4 in directing and capturing the ice. While barrel 3 has been described herein as including a cylindrical shape, this is not to be construed as limiting the present invention as barrel 3 may be formed as any hollow container having any cross-sectional shape, such as square, rectangle, octagon, pentagon, or any other polygonal shape.

Ice barrel 3 stores ice until ice dispensing action is initiated. A majority of the time, the ice dispensing system is at a first or idle (i.e., not rotating during a dispensing cycle) position, and barrel opening 4 is aligned with input chute 2 in an upwards orientation, with the at least one drain hole 7 in a downwards orientation. The at least one drain hole 7 is positioned opposite opening 4 such that when barrel 3 is at the idle position, it is in the lowest part of barrel 3 for drainage of melting ice water. Opening 4 is aligned and generally sealed only to input chute 2 which is, in turn, aligned and generally sealed directly to the output of a conventional ice machine 1. This configuration makes for a very well insulated container which allows minimal ambient heat exchange and also benefits from the condenser and cooling function built into conventional ice machine 1. The ice dispensing system may further include a secondary cooling unit 8 that further cools ice barrel 3 to below freezing temperatures by inserting additional cooling at input chute 2.

With reference to FIGS. 1 and 2, ice barrel 3 is positioned and held in place by drive system 5. Drive system 5 is manually driven by a human powered lever for small implementations of the method. In larger implementations of the system, the drive system 5 is mechanically driven by some type of non-human powered mechanical drive, such as, but not limited to, an AC motor, a DC motor, or a pneumatic drive mechanism. Drive system 5 may also contain a standard, conventional braking system 6 to hold barrel 3 in position when at the first or idle position (see FIG. 2) and optionally at a second or discharge position. The combination of drive system 5 and braking system 6 shown in FIG. 1 is a standard AC brake motor which works as both the drive and brake system. However, these two functions do not need to be contained in a single unit.

With reference to FIGS. 2 and 3, opening 4 accepts ice falling from ice machine 1 though input chute 2 while at a first or idle position (see FIG. 2) and dispenses ice into output chute 14 when barrel 3 is rotated to a second or discharge position (see FIG. 3).

For example, as ice accumulates in barrel 3, standard industrial sensors indicate to the controls of the system that a sufficient quantity of ice is present in barrel 3 to allow ice dispensing. In the case where an excess of ice accumulates in the barrel and an overflow begins up into input chute 2, ice machine 1 will temporarily suspend ice production in an identical way that it does when placed above a traditional ice storage bin which becomes full and overflows. As soon as barrel 3 is rotated to dispense ice, the excess room in barrel 3 immediately fills up with ice from input chute 2 on the next rotation and ice making machine 1 begins producing ice again.

To dispense, barrel 3 is rotated clockwise from the first or idle position (see FIG. 2) through one complete revolution. Each revolution of barrel 3 dispenses a regulated portion of ice based on the size and geometry 15 of opening 4 of barrel 3. Blade or scoop 17, if present, aids opening 4 in directing and capturing the ice. The amount of ice dispensed is consistent with each revolution independent of the amount of ice in barrel 3. Upon initiation of an ice dispensing cycle, drive system 5 begins rotating barrel 3 in a clockwise direction indicated in FIG. 3 by arrow 11. The speed of rotation is not critical but should be fairly slow, such as around 10-20 revolutions per minute (rpm).

As opening 4 moves away from input chute 2, ice is contained by an ice containment system 12. Ice containment system 12 is positioned around a portion of the cylindrical body of barrel 3. The ice containment system 12 has a first end and a second end, which are each configured to be secured to any rigid structure in the vicinity of the ice dispensing device such that ice containment system 12 is positioned around a portion of the cylindrical body of barrel 3. For instance, the first end of ice containment system 12 may be coupled to input chute 2 and a second end may be coupled to output chute 14 as shown in FIGS. 2 and 3. In one embodiment of the present invention, ice containment system 12 is a simple piece of flexible material held with an adjustable tension around barrel 3. The flexible material may be secured to a rigid structure either with or without at least one tensioning spring 16. In other embodiments, ice containment system 12 may be a free spinning mechanical conveyor belt system (not shown) held with tension around barrel 3 by tensioning springs. When ice containment system 12 is implemented in such a manner, the conveyor belt system rotates with barrel 3 to reduce friction and torque requirements.

The rotation of barrel 3 agitates the ice therein. In addition, as barrel 3 rotates, the geometry and size 15 of opening 4 directs and captures a regulated amount of ice. Regardless of the quantity of ice contained in barrel 3, and without any need to measure ice by weight, by volume, or any other means, as rotating barrel 3 rotates through approximately 270 degrees of rotation, beginning at the first or idle position (see FIG. 2) and approaching the second or discharge position (see FIG. 3), opening 4 is “charged” with the regulated amount of ice for discharge. While the amount of rotation has been described as approximately 270 degrees, this is not to be construed as limiting the present invention as different amounts of rotation may be utilized depending on the geometry and size 15 of opening 4 of barrel 3.

As barrel opening 4 rotates past the end of ice containment system 12, it aligns with the ice output chute 14 as shown in FIG. 3. At this point, the regulated amount of ice captured in opening 4 due to its geometry and size 15 is released from containment and falls into output chute 14. Output chute 14 is a simple fabrication which directs ice to the most beneficial use required for the application. In the present embodiment, it is a funnel tube used to fill up bags or containers with ice.

Barrel drive system 5 then continues rotating barrel 3 in the direction indicated in FIG. 3 by arrow 11 until barrel 3 has completed its rotation. Braking system 6, when used, then stops barrel 3 at the first or idle position (see FIG. 2) to complete one ice dispensing cycle. Alternatively, a shot pin or other locating device (not shown) may be used to insure that the barrel is in the first or idle position.

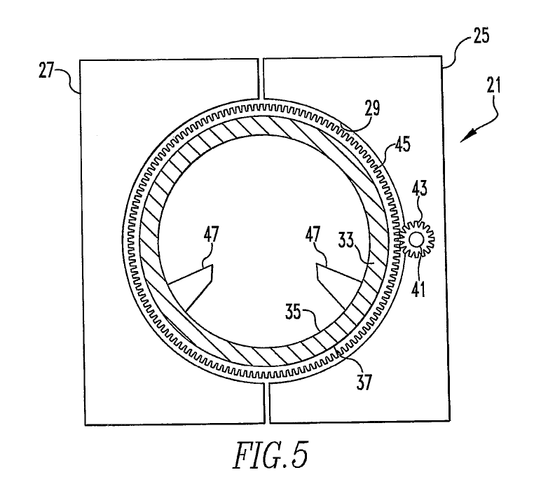

With reference to FIGS. 4 and 5, an alternative embodiment of an ice dispensing system 20 includes an input chute 2, communicating and directing ice into a housing 21 through a housing opening 23. Input chute 2 is positioned under any conventional ice machine 1 of various types, makes, and manufacturers in place of where an ice holding bin would typically be placed. Conventional ice making machine 1 supplies various forms of ice (cubes, crushed, cracked, flaked) to the ice dispensing system of the present invention. The ice produced by ice making machine 1 falls into the dispensing system's input chute 2 and then into housing 21 through opening 23.

Housing 21 include a first section 25 coupled to a second section 27 to form a substantially cylindrical opening 29 therebetween. Opening 23 may be formed in first section 25, second section 27, or equally distributed between first section 25 and second section 27 as shown in FIG. 4. An output opening 31 is also formed in one of first section 25 and second section 27. Output opening 31 is provided in fluid communication with an output chute 14. First section 25 and second section 27 of housing 21 may be injection molded from any suitable polymeric material.

Ice dispensing system 20 also includes a rotating sleeve 33 positioned within substantially cylindrical opening 29 of housing 21 (see FIG. 5). Rotating sleeve 33 has an inner surface 35, an outer surface 37, and an opening (not shown) extending between the inner surface 35 and the outer surface 37. Sleeve 33 is configured to rotate from a first position in which the opening (not shown) aligns with housing opening 23 to a second position in which the opening (not shown) aligns with output opening 31 of housing 21.

A drive system 39 is coupled to sleeve 33 for rotating sleeve 33 between the first position and the second position. Drive system 39 includes a drive shaft 41 coupled to a rotating gear 43. Rotating gear 43 is configured to interact with teeth 45 provided on outer surface 37 of sleeve 33 to cause rotation of sleeve 33. Drive system 39 may also include a braking system (not shown) for stopping rotation of sleeve 33 once it returns to the first position. The use of such a drive system 39 is not to be construed as limiting the present invention as any suitable drive device for rotating sleeve 33 may be utilized.

At least one projection 47 may be provided that extends from inner surface 35 of sleeve 33 for directing ice within sleeve 33. The rotation of sleeve 33 and the at least one projection 47 agitate and direct the ice within sleeve 33.

The opening (not shown) of sleeve 33 has a geometry and size similar to the geometry and size 15 of opening 4 in barrel 3. Accordingly, during operation, ice manufactured by ice making machine 1 enters sleeve 33 through input chute 2 and housing opening 23 when sleeve 33 is in a first position. Thereafter, sleeve 33 is rotated until the opening therein (not shown) is aligned with output opening 31 of housing 21. The opening of sleeve 33 has a size and geometry such that it directs ice within sleeve 33 and captures a regulated amount of the ice during rotation between the first position and the second position and dispenses the regulated amount of ice into output chute 14 when sleeve 33 reaches the second position. Sleeve 33 is then rotated by drive system 39 until it returns to the first position.

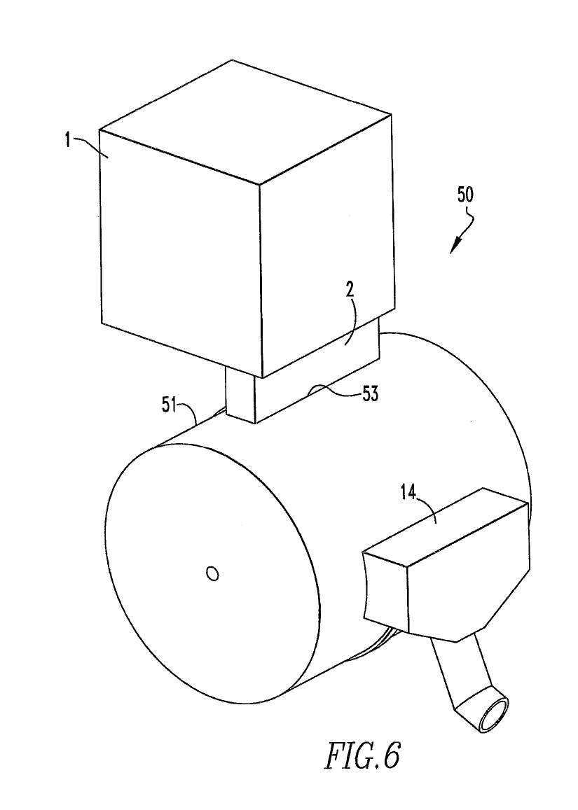

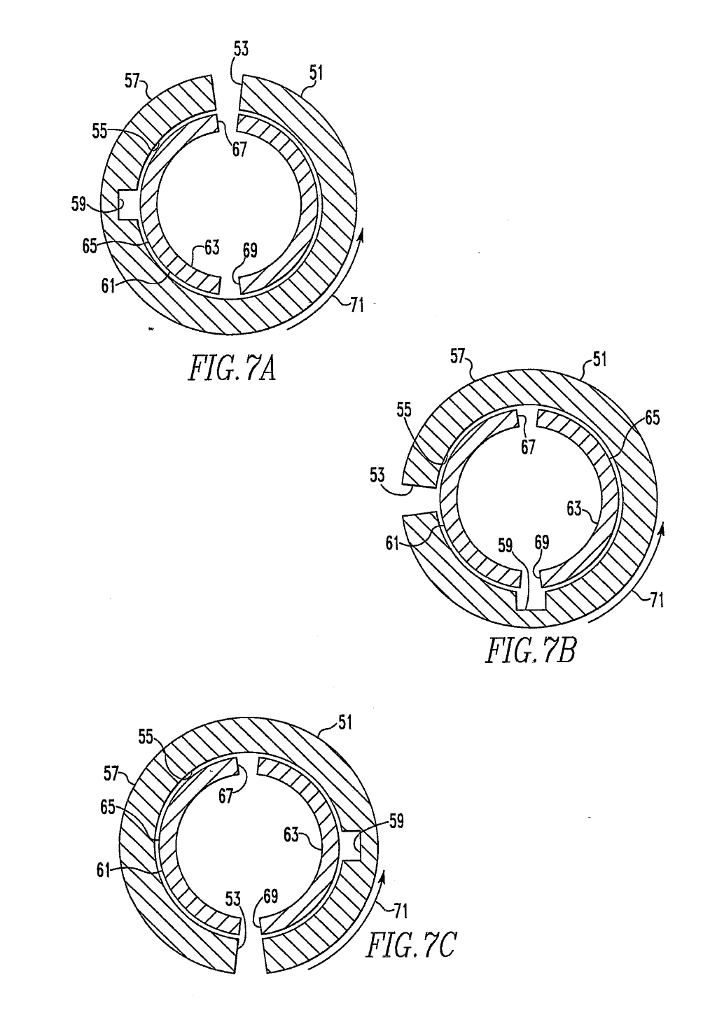

With reference to FIGS. 6 and 7(a)-7(c), another alternative embodiment of an ice dispensing system 50 includes an input chute 2, communicating and directing ice into a rotating housing 51 through a housing opening 53. Input chute 2 is positioned under any conventional ice machine 1 of various types, makes, and manufacturers in place of where an ice holding bin would typically be placed. Conventional ice making machine 1 supplies various forms of ice (cubes, crushed, cracked, flaked) to the ice dispensing system of the present invention. The ice produced by ice making machine 1 falls into the dispensing system's input chute 2 and then into housing 51 through opening 53.

Rotating housing 51 includes a substantially cylindrical body portion with an inner surface 55 and an outer surface 57. Opening 53 extends between inner surface 55 and outer surface 57 and is provided in fluid communication with ice making machine 1 when housing 51 is in a first position as shown in FIG. 7(a). An ice receiving notch 59 is formed in inner surface 55 of housing 51.

Ice dispensing system 50 further includes a sleeve 61 positioned within the cylindrical body portion of housing 51. Sleeve 61 includes an inner surface 63, an outer surface 65, a first opening 67 extending between inner surface 63 and outer surface 65 and in fluid communication with opening 53 in housing 51 when housing 51 is in the first position (see FIG. 7(a)), and a second opening 69 extending between inner surface 63 and outer surface 65 and in fluid communication with ice receiving notch 59 in housing 51 when housing 51 is in a second position (see FIG. 7(b)). At least one projection (not shown) may be provided that extends from inner surface 63 of sleeve 61 for directing ice within sleeve 61. Sleeve 61 and housing 51 may be injection molded from any suitable polymeric material.

Ice dispensing system 50 also includes an output chute 14 in fluid communication with ice receiving notch 59 of housing 51 when housing 51 is in a third position (see FIG. 7(c)). Sleeve 61 remains stationary as housing 51 rotates from the first position to the third position. A drive system (not shown) may be coupled to housing 51 for rotating housing 51 between the first position and the third position. The drive system may include a drive shaft coupled to a rotating gear. The rotating gear is configured to interact with teeth (not shown) provided on outer surface 57 of housing 51 to cause rotation of housing 51. The drive system may also include a braking system (not shown) for stopping rotation of housing 51 once it returns to the first position. The use of such a drive system is not to be construed as limiting the present invention as any suitable drive device for rotating housing 51 may be utilized.

In operation, ice manufactured by ice making machine 1 enters housing 51 and sleeve 61 through input chute 2 and openings 53 and 67 when housing 51 is in a first position as shown in FIG. 7(b). Thereafter, housing 51 is configured to rotate in the direction of arrow 71 from a first position to a second position such that ice receiving notch 59 is aligned with second opening 69 of sleeve 61 as shown in FIG. 7(b). Ice receiving notch 59 has a geometry and size that receives ice from within sleeve 61 and captures a regulated amount of the ice during rotation of housing 51 between the first position and the second position. Ice receiving notch 59 then dispenses the regulated amount of ice into output chute 14 when housing 51 reaches the third position as shown in FIG. 7(c).

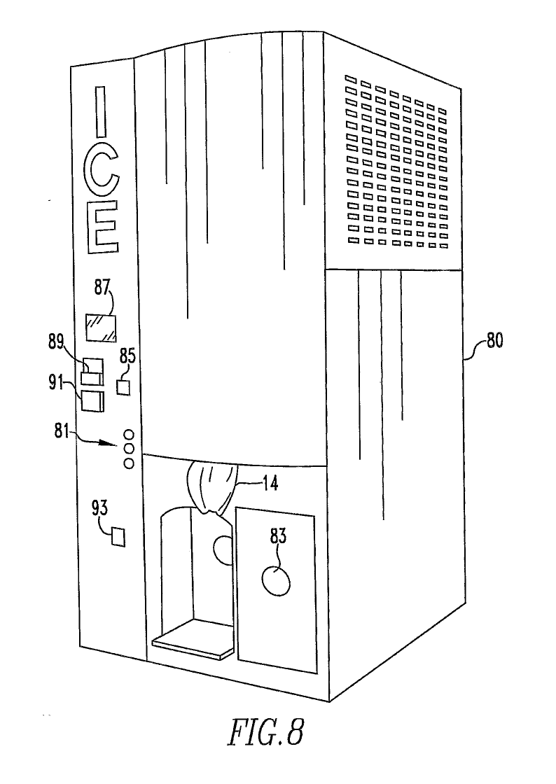

With reference to FIG. 8 and with continuing reference to FIGS. 1-6 and 7(a)-7(c), any one of the above-described ice dispensing systems 10, 20, or 50 may be positioned within a vending machine housing 80. Vending machine housing 80 may include a dispensing actuation interface 81, a payment interface, and a bag dispensing interface 83. The payment interface can include a coin slot 85 that can receive coins, a visual display 87 (e.g., for displaying the amount of payment and the stage of dispensing), a bill slot 89 for receiving paper currency, and/or a slot 91 for receiving debit cards, credit cards, prepaid cards, smart cards, etc. The payment interface can also include a change retrieval area 93 via which the user can retrieve change from the purchase of ice.

In operation, a user approaches vending machine housing 80 and inserts payment via coin slot 85, bill slot 89, or credit card slot 91. Thereafter, the user removes a bag from bag dispensing interface 83 and places the bag around output chute 14 of ice dispensing system 10, 20, or 50. The user then initiates the dispensing of ice using dispensing actuation interface 81 and ice dispensing system 10, 20, or 50 is actuated to dispense ice into output chute 14 and then into the user's bag.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. An ice dispensing system comprising:
a housing comprising a first section coupled to a second section to form a substantially cylindrical opening therebetween, at least one of the first section and the second section having a first opening in fluid communication with an ice making machine and a second opening in fluid communication with an output chute; and
a rotating sleeve positioned within the substantially cylindrical opening of the housing, the rotating sleeve having an inner surface, an outer surface, and an opening extending between the inner surface and the outer surface,
wherein the sleeve is configured to rotate from a first position in which the opening aligns with the first opening of the housing to a second position in which the opening aligns with the second opening of the housing, and the opening has a geometry and size that directs ice within the sleeve and captures a regulated amount of the ice during rotation between the first position and the second position and dispenses the regulated amount of ice into the output chute when the sleeve reaches the second position.

2. The ice dispensing system of claim 1, further comprising a drive system coupled to the sleeve for rotating the sleeve between the first position and the second position.

3. The ice dispensing system of claim 2, wherein the drive system comprises a rotating gear configured to interact with teeth provided on the outer surface of the sleeve to cause rotation of the sleeve.

4. The ice dispensing system of claim 2, wherein the drive system includes a braking system for stopping rotation of the sleeve once it returns to the first position.

5. The ice dispensing system of claim 1, further comprising at least one projection extending from the inner surface of the sleeve for directing ice within the sleeve.

6. The ice dispensing system of claim 5, wherein rotation of the sleeve and the at least one projection agitate the ice within the sleeve.

7. The ice dispensing system of claim 1, wherein the first section and the second section of the housing are injection molded from a polymeric material.

8. The ice dispensing system of claim 1, wherein the ice dispensing system is positioned within a vending machine housing.

9. The ice dispensing system of claim 8, wherein the vending machine housing includes at least one of a dispensing actuation interface, a payment interface, and a bag dispensing interface.

10. The ice dispensing system of claim 9, wherein the vending machine housing includes a visual display for providing an indication to the user of the stage of dispensing.

11. An ice dispensing system comprising:
a rotating housing comprising a substantially cylindrical body portion having an inner surface, an outer surface, an opening extending between the inner surface and the outer surface and provided in fluid communication with an ice making machine when the housing is in a first position, and an ice receiving notch formed in the inner surface;
a sleeve positioned within the cylindrical body portion of the housing, the sleeve having an inner surface, an outer surface, a first opening extending between the inner surface and the outer surface and in fluid communication with the opening in the housing when the housing is in the first position, and a second opening extending between the inner surface and the outer surface and in fluid communication with the ice receiving notch in the housing when the housing is in a second position; and
an output chute in fluid communication with the ice receiving notch of the housing when the housing is in a third position,
wherein the housing is configured to rotate from a first position to a third position, and the ice receiving notch has a geometry and size that receives ice from within the sleeve and captures a regulated amount of the ice during rotation of the housing between the first position and the second position and dispenses the regulated amount of ice into the output chute when the housing reaches the third position.

12. The ice dispensing system of claim 11, further comprising a drive system coupled to the housing for rotating the housing between the first position and the third position.

13. The ice dispensing system of claim 12, wherein the drive system comprises a rotating gear configured to interact with teeth provided on the outer surface of the housing to cause rotation of the housing.

14. The ice dispensing system of claim 12, wherein the drive system includes a braking system for stopping rotation of the housing once it returns to the first position.

15. The ice dispensing system of claim 11, further comprising at least one projection extending from the inner surface of the sleeve for directing ice within the sleeve.

16. The ice dispensing system of claim 11, wherein the sleeve remains stationary as the housing rotates.

17. The ice dispensing system of claim 11, wherein the housing and the sleeve are injection molded from a polymeric material.

18. The ice dispensing system of claim 11, wherein the ice dispensing system is positioned within a vending machine housing.

19. The ice dispensing system of claim 18, wherein the vending machine housing includes at least one of a dispensing actuation interface, a payment interface, and a bag dispensing interface.

20. The ice dispensing system of claim 19, wherein the vending machine housing includes a visual display for providing an indication to the user of the stage of dispensing.
